(19) United States
(12) Patent Application Publication
(10) Pub. No.: US 2009/0220929 A1
(43) Pub. Date: Sep. 3, 2009

(54) PC-BASED SIMULATOR TRAINING SYSTEM AND METHODS

(76) Inventor: Warren C. Daniel, Crystal Lake, IL (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/293,121

(22) PCT Filed: Mar. 15, 2007
(86) PCT No.: PCT/US2007/064077

§ 371 Date: Jan. 12, 2009

Related U.S. Application Data
(60) Provisional application No. 60/783,283, filed on Mar. 17, 2006.
(60) Provisional application No. 60/790,670, filed on Apr. 10, 2006.

(51) Int. Cl. G09B 7/00

(52) U.S. Cl. 434/362

(57) ABSTRACT

A simulation training system having a network system (10) establishing communications among a trainee client domain (20), a trainer client domain (30), a simulation training server system (40), and a simulation training database system (50). In operation, the trainee client domain (20) and the simulation training server system (40) provide an objective simulation certification indicative of a simulated operation of a transportation machine by a simulation trainee. The trainer client domain (30) provides simulation training courseware specifying an objective simulation testing of the simulated operation of the transportation machine by the simulation trainee. And, the simulation database system (50) stores and facilitates a viewing of the objective simulation certification of the simulation trainee.

### RELATED APPLICATION DATA

This application claims the benefit of U.S. Provisional Application Ser. No. 60/783,283 filed on Mar. 17, 2006, and the benefit of U.S. Provisional Application Ser. No. 60/790,670 filed Apr. 10, 2006. The entirety of each application is hereby incorporated by reference.

### FIELD OF THE INVENTION

The present invention generally relates to personal computer (“PC”)-based simulation training of transportation machines of any type (e.g., fixed-wing aircraft, rotorcraft, naval ships, submersibles, vehicles, drones, space craft, etc.). The present invention specifically relates to PC-based simulation training for facilitating an interactive environment involving simulation trainees (e.g., pilots, ship captains, tank drivers, astronauts, mission specialists, crew members, etc.) and simulation trainers (e.g., instructors, evaluators, mission controllers, observers, etc.).

### BACKGROUND OF THE INVENTION

PC-based simulation training is a beneficial form of training of transportation machines for simulation trainees. However, there is a need to further expand and advance the use of PC-based simulation training, particularly in the development of a PC-based simulation certification tool.

Specifically, various PC-based flight simulators have been historically created for gaming purposes and more recently have been used in a very limited manner as a flight simulation training tool (e.g., Microsoft® Flight Simulator). Additionally, other PC-based flight simulators have been created for simulation training purposes, but serve more as informational training tools rather than comprehensive flight simulation training tools (e.g., CAE Simfinity®). Moreover, the programming nature of these PC-based flight simulators are not sufficient to serve as comprehensive flight simulation training tools due to a couple of deficiencies in their programming approach. First, a current philosophy of existing PC-based flight simulators are to fulfill a specific area or role that does not require or acknowledge the existence of additional features and an interaction among such features together as a whole that is needed to transform the existing PC-based flight simulators into comprehensive flight simulation training tools. Second, current programming structures of existing PC-based flight simulators fail to provide an overall integration of all necessary functionality to construct the existing PC-based flight simulators into comprehensive flight simulation training tools.

### SUMMARY OF THE INVENTION

The present invention provides a new and unique PC-based simulation training system and methods that serve to provide a comprehensive simulation training tool.

In one form of the present invention, a simulation training system comprises a trainee client domain including at least one trainee client device, a simulation training server system including at least one simulation training server and a network system establishing communication between the trainee client domain (20) and the simulation training server system. In operation, the trainee client domain (20) and the simulation training server system provide an objective simulation certification indicative of a simulated operation of a transportation machine by a simulation trainee.

In a second form of the present invention, a simulation training system comprises a processor, and a memory storing instructions operable with the processor for executing an interaction among distinct modules facilitating a simulation of a transportation machine for purposes conducting an objective simulation certification indicative of a simulated operation of the transportation machine by a simulation trainee. The instructions are executed for a transportation machine module providing a model of the transportation machine, a scenario/mission module providing at least one of a scenario and a mission associated with the simulated operation of the transportation machine by the simulation trainee, and an environment module providing environmental setting associated with the simulated operation of the transportation machine by the simulation trainee.

The aforementioned forms and other forms as well as objects and advantages of the present invention will become further apparent from the following detailed description of various embodiments of the present invention read in conjunction with the accompanying drawings. The detailed description and drawings of the various embodiments of the present invention are merely illustrative of the present invention rather than limiting, the scope of the present invention being defined by the appended claims and equivalents thereof.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1 illustrates a block diagram of one embodiment in accordance with the present invention of a PC-based simulation training environment;

FIG. 2 illustrates a schematic diagram of an exemplary embodiment in accordance with the present invention of the PC-based flight simulation training environment illustrated in FIG. 1;

FIG. 3 illustrates a block diagram of one embodiment in accordance with the present invention of a PC-based simulation training multimedia application;

FIG. 4 illustrates a block diagram of one embodiment in accordance with the present invention of a transportation machine module illustrated in FIG. 3;

FIG. 5 illustrates a block diagram of one embodiment in accordance with the present invention of a scenario/mission module illustrated in FIG. 3;

FIG. 6 illustrates a block diagram of one embodiment in accordance with the present invention of an environment module illustrated in FIG. 3;

FIG. 7 illustrates a block diagram of one embodiment in accordance with the present invention of a PC based simulation training courseware application;

FIG. 8 illustrates a flowchart representative of one embodiment in accordance with the present invention of a layered module integration method;

FIG. 9 illustrates a flowchart representative of one embodiment in accordance with the present invention of a PC based simulation certification method; and

FIG. 10 illustrates a flowchart representative of one embodiment in accordance with the present invention of a simulation performance grading method.

### DETAILED DESCRIPTION OF THE INVENTION

PC-based simulation in accordance with the present invention allows for simulation trainees and simulation trainers (e.g., pilots, mission specialists, training instructors, and observers) to all come together in a full interactive environment. This concept applies to any type of transportation device including, but not limited to, fixed-wing aircraft, rotorcraft, naval ships, submersibles, vehicles, drones, space craft, and the like. An interactive environment of the present invention may consist of (1) single-machine/single-person, (2) single-machine/multi-crew, (3) multi-machine/multi-crew and (4) transportation machines in solo scenarios and/or theater/campaign wide scenarios.

For example, as related to flight simulation, using personal computers on a secured network environment in accordance with the present invention provides simulation trainees with 2D- and 3D-interactive environments to learn their aircraft types, to practice complex multiplayer missions and scenarios, and to accomplish their mission or scenario objectives as an individual and/or as part of a team. Concurrently, also in accordance with the present invention, a simulation trainer will use the PC-based simulation environment to evaluate a simulation trainee's performance, and inject changes to the aircraft, environment, or mission, as the simulation trainee learns his/her aircraft expected behavior, and react in a rapidly changing environment. The simulation trainer will evaluate the simulation trainee's performance—real-time or as recorded video or data taken from the simulator.

In the PC-based simulation environment of the present invention, simulation trainers will be able to log in and view a simulation trainee's performance real-time for training, government, or regulatory purposes. Additionally, the training facility will hold simulation trainee performance records, and will be able to send these records to a government or regulatory repository database for storage of the performance records.

This entire process will take place over one or more secured networks, using user validation, authentication, and data-encryption across the secure network(s).

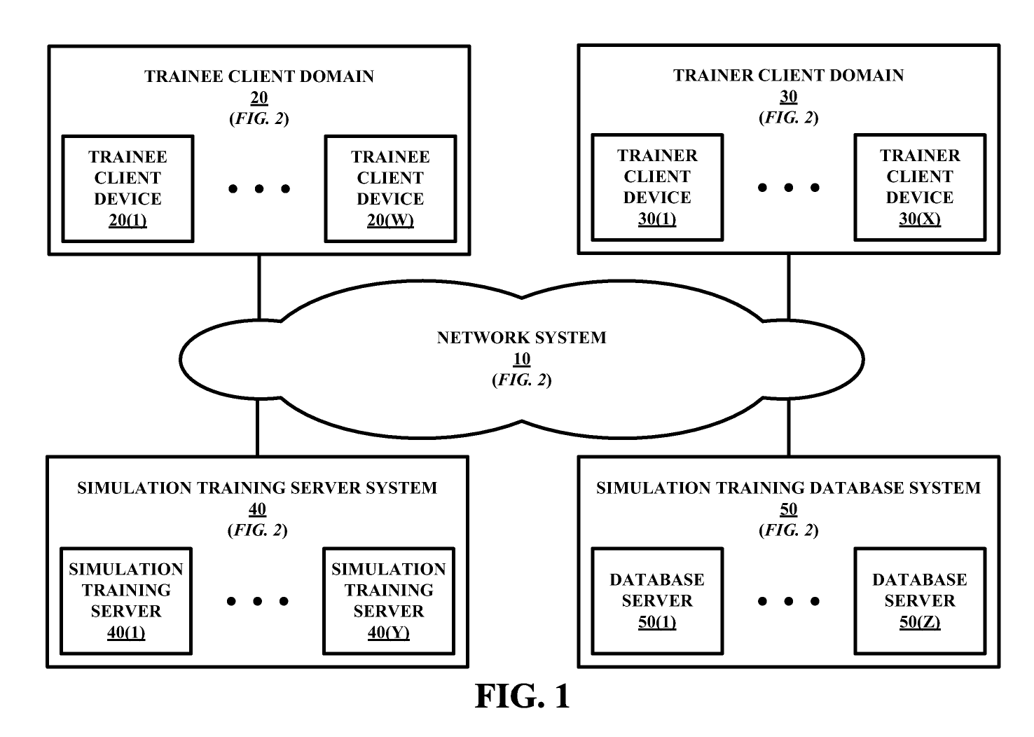

FIG. 1 illustrates a PC-based environment in accordance with the present invention. A network system 10 of any form is provided to facilitate various communication channels between a trainee client domain 20, a trainer client domain 30, a simulation training server system 40 and a simulation training database system 50 (e.g., an internet, an intranet, or a combination of both networks).

Trainee client domain 20 encompasses a W number of trainee client devices of any form of personal computer including, but not limited to, desktops, laptops, personal data assistants, mobile phones and the like. The trainee client devices are generally structurally configured as known in the art for facilitating a connection to simulation training server system 40 via network system 10 by PC based simulation trainees of any type including, but not limited to, pilots, ship captains, tank drivers, astronauts, mission specialists, crew members and the like.

Trainer client domain 30 encompasses a X number of trainer client devices of any form of personal computers including, but not limited to, desktops, laptops, personal data assistants, mobile phones, monitors and the like. The trainer client devices are generally structurally configured as known in the art for facilitating a connection to simulation training server system 40 via network system 10 by PC based simulation trainers of any type including, but not limited to, instructors, evaluators, mission controllers, observers and the like.

Simulation training server system 40 encompasses a Y number of simulation training servers of any form including, but not limited to, an application server, a multimedia server, a web server, an e-commerce server, a file management server, a security server, and the like. The simulation training servers 40 are generally structurally configured for facilitating a connection to trainee client domain 20, trainer client domain 30 and simulation training database system 50 via network system 10.

Trainer client domain 20, trainer client domain 30 and/or the simulation training server system 40 are specifically structurally configured in accordance with the present invention to implement courseware training for simulation trainees on a particular type of transportation machine including, but not limited to, fixed-wing aircraft, rotorcraft, naval ships, submersibles, vehicles, drones, space craft, and the like.

For example, for flight simulations, courseware scenarios typically included in a training syllabus for airline transport pilot certification can encompass (1) normal procedures (e.g., full flight, takeoff in adverse weather conditions, landing in adverse weather conditions), (2) abnormal procedures (e.g., engine relight (in flight), engine failure strategies (obstacle clearance), autopilot/mcdu failure, slats/flaps jammed—landing, no flaps/slats—landing, fuel imbalance, landing with abnormal landing gear (gear jammed) and overweight landing), and (3) emergency procedures (e.g., full hydraulic system failure and loss of braking—landing).

Simulation training database system 50 encompasses a Z number of database servers of any form that are generally structurally configured as known in the art for facilitating a connection to simulation training server system 40 via network system 10 to thereby obtain and store trainee performance records and trainer evaluations generated by a simulation interaction between trainee client domain 20 and trainer client domain 30 via simulation training server system 40.

In practice, the present invention does not impose any limitations or any restrictions to structural forms of network system 10, trainee client domain 20, trainer client domain 30, simulation training server system 40 and simulation training database system 50 within the inventive principles of the present invention.

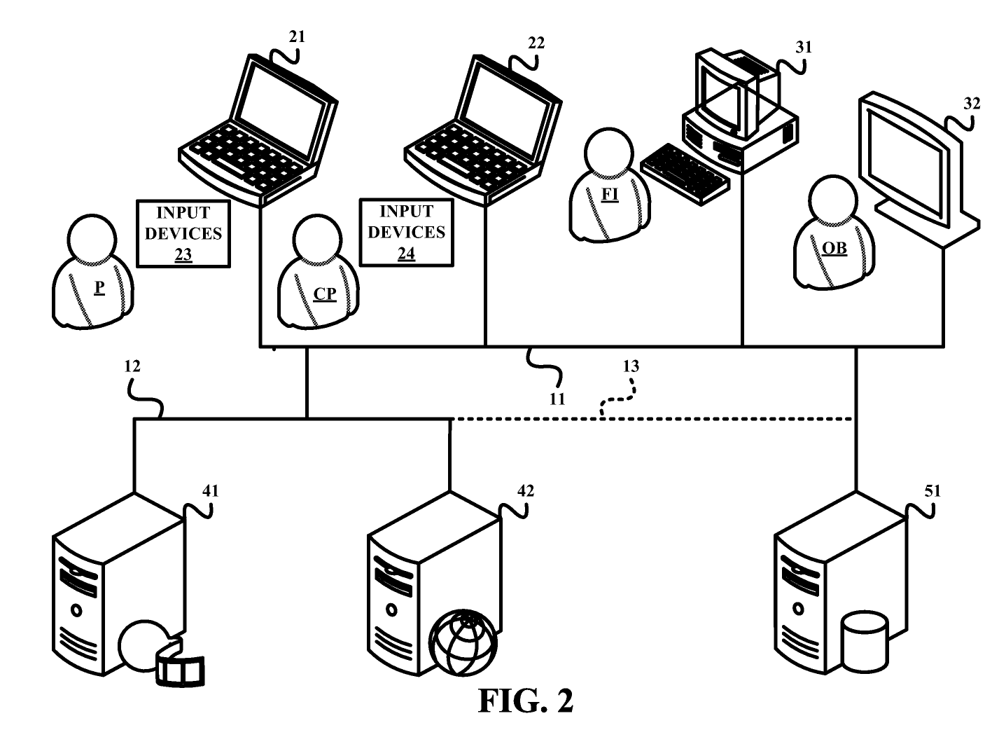

FIG. 2 illustrates an exemplary PC-based flight simulation training environment. As shown, in the trainee client domain 20 (FIG. 1), a pilot (“P”) and a co-pilot “CP”) are respectively interfacing with a laptop 21 and a laptop 22, both of which are connected to an internet 11. For basic flight simulation controllers, pilot P and co-pilot CP can use the keyboard and/or mouse of respective laptops 21 and 22. For more advance flight simulation controllers, pilot P and co-pilot CP can use respective inputs devices 23 and 24 including, but not limited to, joysticks, gamepads, instrument panels, touch screens, glasses, goggles, gloves, helmets, head-mounted display units, functional layouts, mechanisms, motion sensors with motion tracking, and eye/brain/thought input.

In the trainer client domain 30 (FIG. 1), a flight instructor (“FI”) is shown interfacing with a desktop 31, which is connected to internet 11, and an observer (“OB”) is shown watching a training monitor 32, which is also connected to internet 11.

For simulation training server system 40 (FIG. 1), a multimedia server 41 and a web server 42 are shown connected to an intranet 12, which is connected to internet 11 for purposes of providing flight simulation training to pilot P and copilot CP as directed by flight instructor FI and monitored by observer OB.

For simulation training database system 50 (FIG. 1), a database server 51 is shown connected to internet 11 to obtain and store performance records and evaluations of pilot P and copilot CP. Alternatively or concurrently, database server 51 can be connected to intranet 12 as indicated by a dashed line 13.

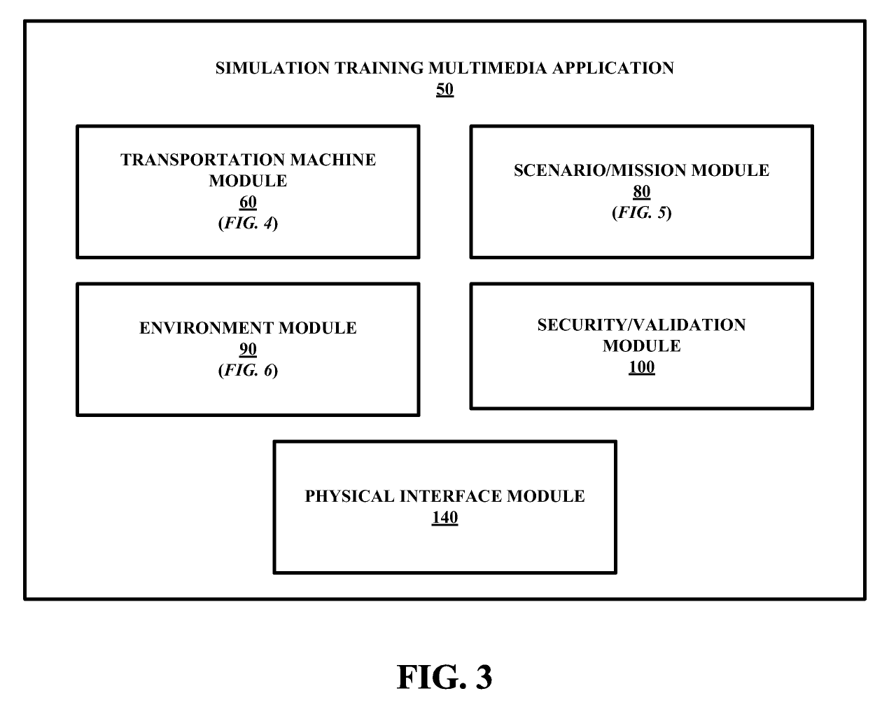

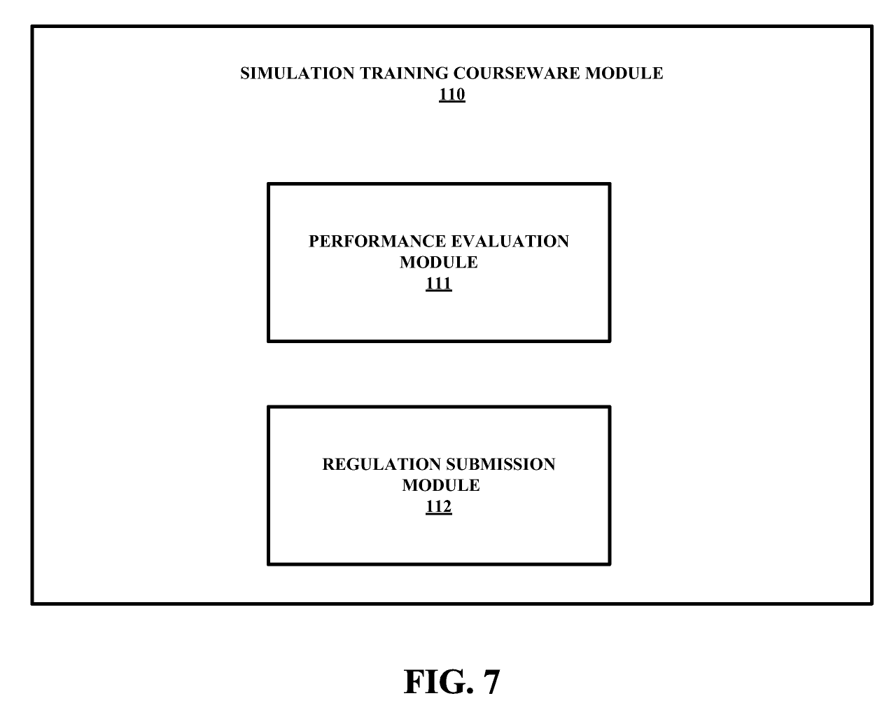

To serve a comprehensive simulation training tool, the processors and memories of laptops 21 and 22, desktop 31 and/or multimedia server 41 and web server 42 are structurally configured to implement a simulation training multimedia application 50 as shown in FIG. 3, and desktop 31 and/or multimedia server 41 and web server 42 are structurally configured with a simulation training courseware application 110 as shown in FIG. 7.

As shown in FIG. 3, a transportation machine module 60 of application 50 provides all the section necessary to make a model of a transportation machine in three dimensions including, but not limited to, the physical layout, physics package, electronics package, ECM, systems, and expected behavior.

A scenario/mission module 80 of application 50 provides the necessary elements to define the mission or scenario including, but not limited to, the mission profile/goals/objectives, aircraft/naval systems failure code, attack data, defense data, and expected behavior.

An environment module 90 of application 50 provides environmental conditions within an environmental setting which will be set, changed, or updated real-time from data from government websites such as National Oceanic & Atmospheric Administration (“NOAA”) and others including, but not limited to, updates for atmospheric conditions, oceanic currents/surface conditions/submerged and surface temperature differentials/underwater/above-water topography, radiation and radiological conditions from space/solar flares/solar winds/solar conditions/combat and missile battlefield nuclear radiation conditions.

A physical interface module 140 of application 50 provides the channels, for both “conventional” reality and “virtual” reality, by which simulation trainees interface with application 50. Specifically, trainee client devices include simulation controllers which the operator uses to control the simulated transportation machine (e.g., conventional and virtual input devices) and physical interface module 140 is used to simulate the human body in a simulated natural environment interacting with the simulation controllers which are present in a true environment.

Finally, a security/validation module 100 can be provided for application 50 to secure and validate users of the network by Quantum Cryptography, and conventional cryptography and encryption whereby the network environment will include validation, encryption, secure storage, and secure network transport.

In practice, the present invention does not impose any limitations or any restrictions to structural forms of transportation machine module 60, scenario/mission module 80, environment module 90, security/validation module 100 and physical interface module 140 within the inventive principles of the present invention.

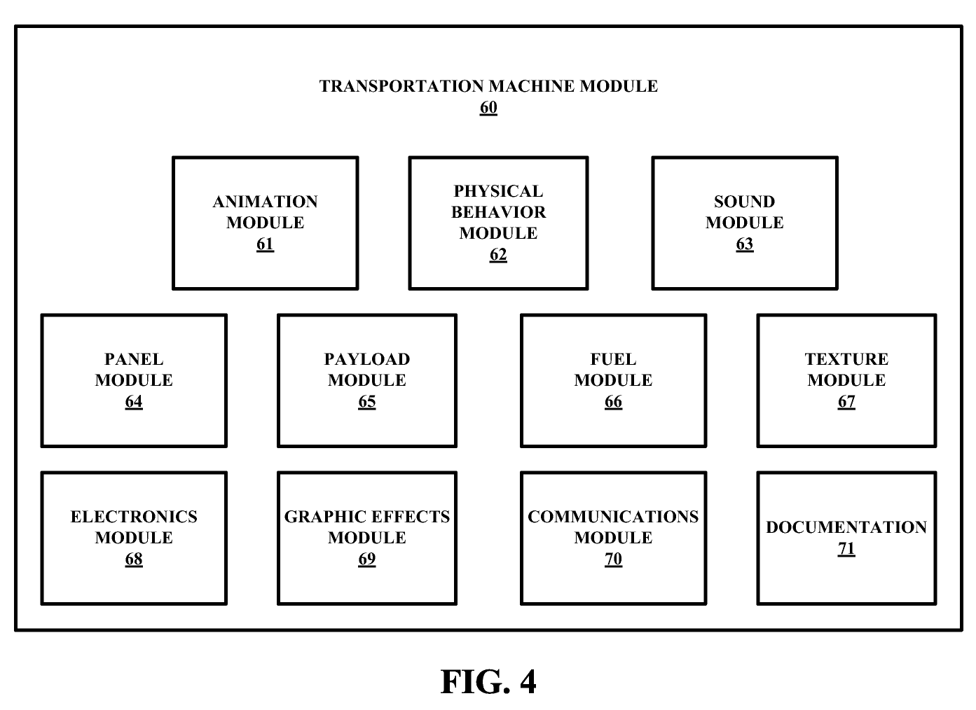

FIG. 4 illustrates an exemplary embodiment of transportation module 60.

As shown, an animation module 61 defines all moving parts on a model of a transportation machine. This is done by creating 3D separate parts of the model, then animating the parts or their behavior.

A physical behavior module 62 defines all physical characteristic of how the model will behave in the 3-D environment. This is done by entering the physical dimensions and properties of the model, which shall interact with the scenario/mission module 80 and environment module 90.

A sound module 63 defines the sounds for the model. This is done by recording sounds, then assigning values and timing to the sounds to recreate the sound and feel of the model.

A panel module 64 defines the 2D/3D panel and internal environment. This is done by 3D vectoring and painting, and/or captured images of the transportation machine which is modeled.

A payload module 65 defines what is loaded into the model and how it effects the physical behavior. This is programmed into the physical package, and affects the transportation machine, scenario/mission module 80 and environment module 90.

A fuel module 66 defines the fuel, material, or resource used to propel the model. This is done by entering the specification into the model physical package, and affects the transportation machine, scenario/mission module 80 and environment module 90.

A texture module 67 defines what is seen on the model, where traditionally skin is wrapped around the polygon or model parts. Textures may be made as artwork, vectored graphics or images captured from the transportation machine which is modeled.

An electronics module 68 defines the equipment, electronics, avionics, used at the method to control the model, or function performed by simulation trainees to information input and output. Typically the electronics are created for the transportation machine, and the functionality is recreated or mimicked and placed into panel module 64. This module 68 affects the transportation machine and accepts input from scenario/mission module 80 and environment module 90.

A graphic effect module 69 defines controlling effects which are external to the model. Effects are timed to an event defined with physical properties.

A communications module 70 defines communication between multiple simulation trainees or multiple transport machines. This allows for multi-simulation trainees to communicate with each other in the environment.

A documentation module 71 defines all documentation (e.g., operations manuals, reference manuals) that must be accessible in the 3D environment as the counterpart physical medium. The documentation is made available and accessible in the environment.

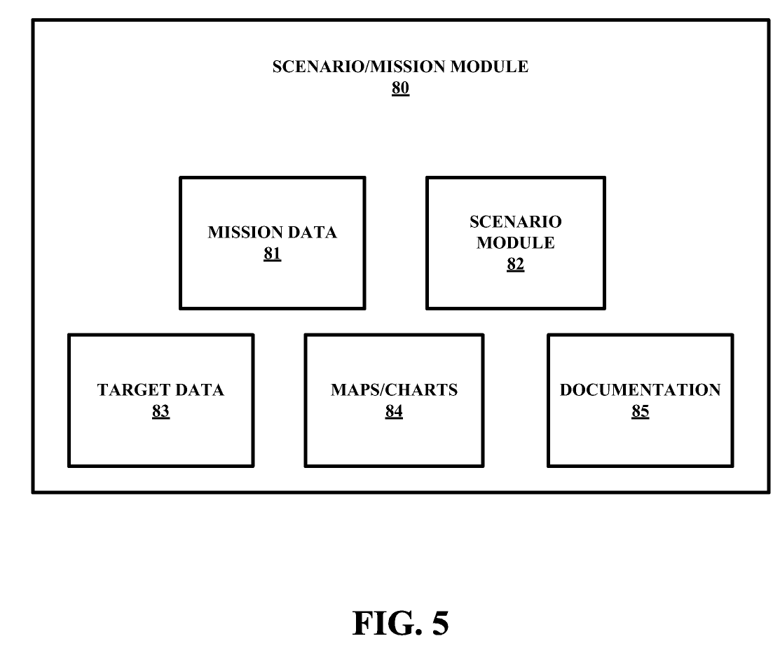

FIG. 5 illustrates an exemplary embodiment of scenario/mission module 80.

As shown in FIG. 5, a mission data module 81 defines a collection of mission specific information including, but not limited to, location, purpose, and method.

A scenario module 82 defines collection of scenario specific information including, but not limited to, the physical environment, and external and dynamic changes to modules 60, 80 and 90 (FIG. 3).

A target data module 83 defines data on the objective or target for attack or defense. The target is modeled into the environment.

A maps/charts module 84 defines necessary parts of the physical environment documentation, necessary for mission planning and execution.

A documentation module 85 defines mission/scenario specific documentation necessary to carry out the task(s), particularly available in the 3D environment.

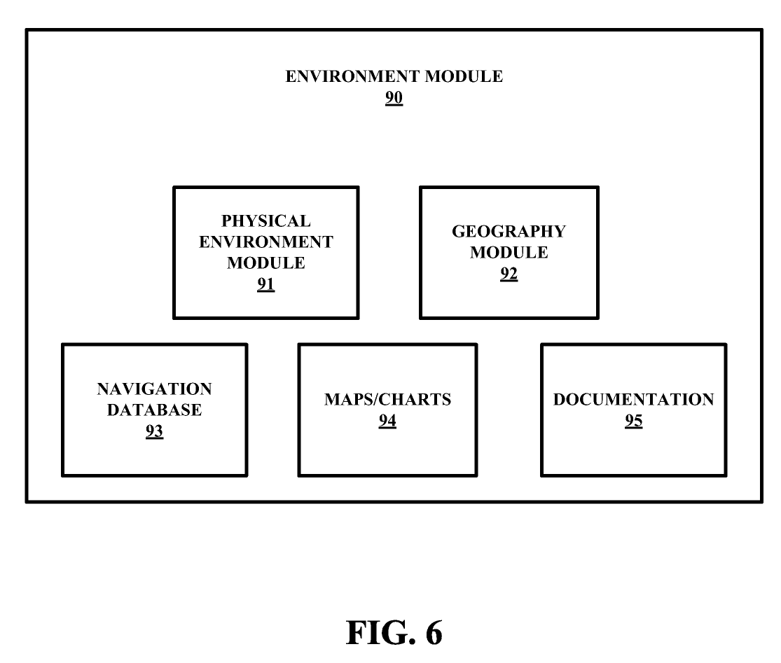

FIG. 6 illustrates an exemplary embodiment of environment module 90.

As shown in FIG. 6, a physical environment module 91 defines environment made from real world, or simulated world topography, features, and variables including, but not limited to, components for gravity, drag, wind resistance, water resistance, friction and adhesion.

A geography module 92 defines data on the physical aspects of a location. Information taken from real world sources such as the USGS, or created for mission data.

A navigation database 93 defines current and future navigation databases including, but not limited to, longitude, latitude, GPS, radios, intersections and waypoints.

A maps/charts module 94 defines maps and charts in the environment module 90 that must be viewable as environment conditions, which are read into the simulator.

A documentation module 95 defines changes to the environment to be available in full 3D mode.

FIG. 7 illustrates simulation training courseware module 110, which defines items necessary to integrate courseware and simulation trainer interaction, including, but not limited to, simulation trainer real-time interaction, simulation trainer media review, ability to change the Mission/Scenario by data injection, and the ability to change the various modules real-time to introduce a dynamic environment and conditions. In particular, simulation trainers will be able to submit the simulation trainee certifications and results to a government or regulatory database via an automated process.

A performance evaluation module 111 of module 110 is responsible for simulation trainer review of simulation trainee actions and performance. In one embodiment, the simulation trainer has the ability to view performance real time or afterwards from data output, alter mission, environment or transportation machine. Further, the simulation trainer has ability to instruct, pass, fail students based on performance.

A regulation submission module 112 allows for the simulation trainer to submit simulation performance records to a government or regulatory database.

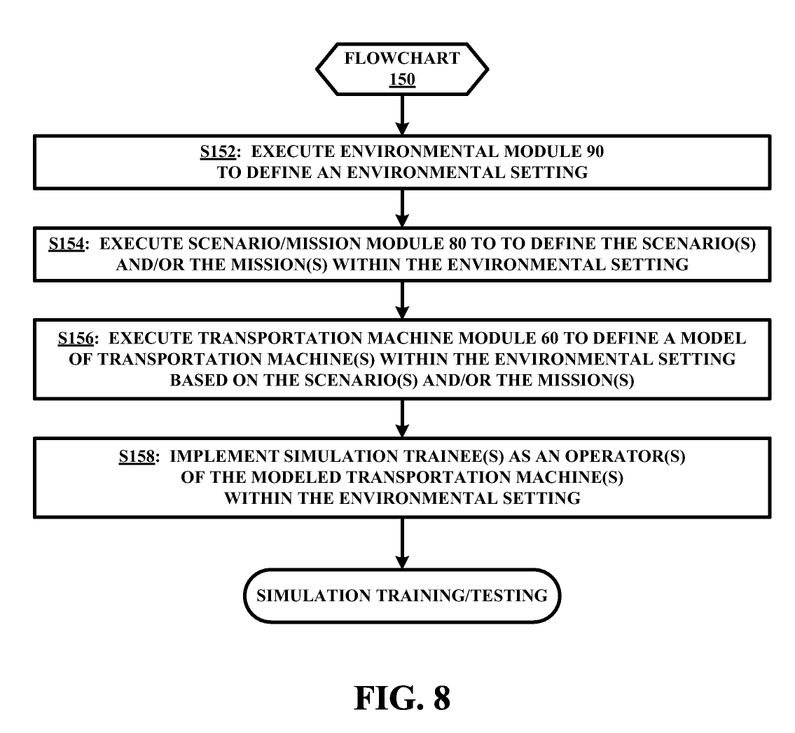

Referring to FIG. 3, simulation training multimedia application is preferably implemented in a layered module integration format of modules 60, 80, 90 and 140 in any programming language for facilitating a comprehensive simulation training tool (e.g., programming language C with the ability to read C and XML). FIG. 8 illustrates a flowchart 150 representative of a layered module integration method of the present invention.

Referring to FIG. 8, a stage S152 of flowchart 150 encompasses an execution of environment module 90 to define environment setting for simulation training/testing purposes. Based on the conditions of the environmental setting, a stage S154 of flowchart 150 encompasses an execution of scenario/mission module 80 to define the scenario(s) and the mission(s) within the environmental setting. With the scenario(s) and the mission(s) established within the environment setting, a stage S156 of flowchart 150 encompasses an execution of transportation machine module 160 to define a model of one or more subject transportation machine within the environmental setting based on the scenario(s) and the mission(s). The layered integration of modules 60, 80 and 90 as provided for by stages S152-S156 facilitates an implementation of simulation trainee(s) during a stage S158 of flowchart 150 as operator(s) of the modeled transportation machine(s) within the environmental setting in view of input provided by the simulation trainees via physical interface module 140 and in view of the interaction among modules 60, 80 and 90 as taught herein. Simulation training/testing commences upon implementation of the simulation trainee(s) as transportation machine operator(s).

Referring to FIGS. 3-8, the modeled layer format of modules 60, 80 and 90 facilitates a performance of the following new and unique simulations functions as related to flight simulation: (1) the ability to design FDE with a GUI, (2) import a 3-D image on GUI overlay for FDE design, (3) calculate wing surface areas based on 3D overlay, (4) calculate control surface area based on 3D overlay, (5) simulate tire profile, wheel profile and strut profile separately, (6) allow for an infinite number of weight stations, (7) allow for an infinite number of landing gear, (8) distribute fuel weight based on GUI overlay, (9) distribute payload station weight (pax classes, freight configuration) based on GUI overlay, (10) able to simulate dry conditions, rain—stopping distances, tire side slip, snow, compacted snow and ice, (11) able to burst tire profiles, (12) able to loss of directional control from burst tires, (13) able to collect heat in tires, loss of braking, (14) heat—melted tires, loss of directional control, (15) able to have engine FOD based on objects—bird, burst tires, runway FOD, (16) weather, (17) accurate start map, (18) full navigation database, (19) read weather from the internet, (20) able to distinguish CATI, II, III, IV capable airports. (21) have photo realistic scenery, (22) able to separate spoiler number, on roll spoilers vs. lift dump, vs. landing only.—this must be configurable to effect FDE, (23) able to simulate icing conditions, (24) gauge failures, (25) true electrical failures, (26) true RAT effect, (27) true APU power, (28) true-hydraulic failure by system, (29) true-multiple hydraulic system failure, (30) true loss of control surfaces (for instance damage due to bird strike, missile attack, airborne strike, (31) ability to record video properly, directly in the simulator, (32) ability to provide true instance playback showing all control surfaces in the sim, (33) able to damage specific parts—rudder over aggressive movement, wing damage due to G stress, etc., (34) truly keep the airplane straight on engine out flight, no side slip flight, (35) ability to lock out control surfaces (which surfaces, over and under 280 knots for example) have 2 different roll rates, (36) ability for the simulator to true separate FDEs, or preferably, set the condition, only need 1 designed FDE, (37) ability for the simulator to drop the plane in flight, without instability on loading, airplane height loss, airspeed loss, trim, pitching up/down, (39) all attributes of the nav database must able to be interrogated by the aircraft FMC and autopilot, (40) smoothened weather transition than other simulators, (41) able to truly load and remember the scenario information based on a preprogrammed/saved flight, (42) include a walk around program, (43) visual models must show random failures/mis configuration for walk around, (44) want virtual reality glasses, ability to do 3D cockpit without monitors, (45) ability to grab controls and flip controls/buttons without the need of a mouse, yoke or control stick, (46) virtual reality with gloves or sensors to make the changes, (47) able to operate on WINDOWS, LINUX or UNIX platforms, (48) MAC OS if necessary, (49) true CG movement effect for weight, (50) better trim control, (51) ability to simulate trim/rudder runaway, (52) have mountains, terrain for obstacle clearance, (53) have top 200 airports detailed scenery in 3D, (54) airport database based on true nav charts, (55) have ability for multiplayer in virtual reality—ability to perform flight pilot, non-flying pilot training over the internet, Ethernet, together or remote, (56) multiplayer for multiple planes, (57) ability to import true aircraft flightplans from dispatch. Must be able to import and create savable database, as well as allow for pilot constraint entries, (58) all icons matching individual airplanes, (59) have a team which will work with us to implement these, support the product, and do update, (60) engine vibration, imbalance, lose of fan blades, destruction of engine, and (61) walk around showing show these items.

Those having ordinary skill in the art will appreciate how the above functions as well as other new and unique functions can be applied to other types of transportation machines.

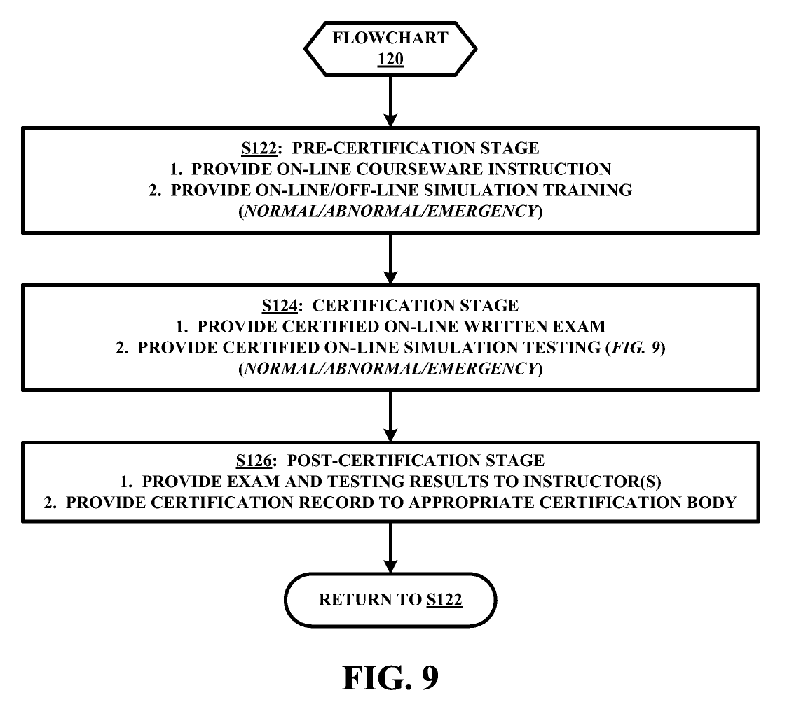

FIG. 9 illustrates a flowchart 120 representative of a PC-based simulation certification method of the present invention. A pre-certification stage S122 of flowchart 120 encompasses trainee client devices 20 and/or system 40 (FIG. 1) providing on-line courseware instruction for simulation trainees and on-line/off-line simulation training/testing for simulation trainees. In one embodiment, the provision of the on-line courseware instruction and on-line/off-line simulation training/testing includes a normal procedure section, an abnormal procedure section and an emergency procedure section as approved by simulation trainer(s) (e.g., instructors). As related to pilot training, the normal procedure section exemplarily provides for a full flight simulation involving a variety of weather conditions, particularly during a takeoff and a landing of the aircraft. The abnormal procedure sections exemplarily provides for an engine relight, engine failure strategies, autopilot/MCDU failure, slats/flaps jammed on landing, no flaps/slats on landing, fuel imbalance, landing with abnormal landing gear and on overweight landing. And, the emergency procedure section exemplarily provides for full hydraulic system failure and loss on braking on landing.

A certification stage S124 of flowchart 120 encompasses trainee client devices 20 and/or system 40 providing on on-line written exam for simulation trainees and an on-line simulation testing of simulation trainees. The exam and the simulation testing are certified by an appropriate certification body (e.g., FAA and DoD). Based on his/her dedication to the pre-certification stage S122, a simulation trainee should be properly prepared to pass the exam and the simulation testing.

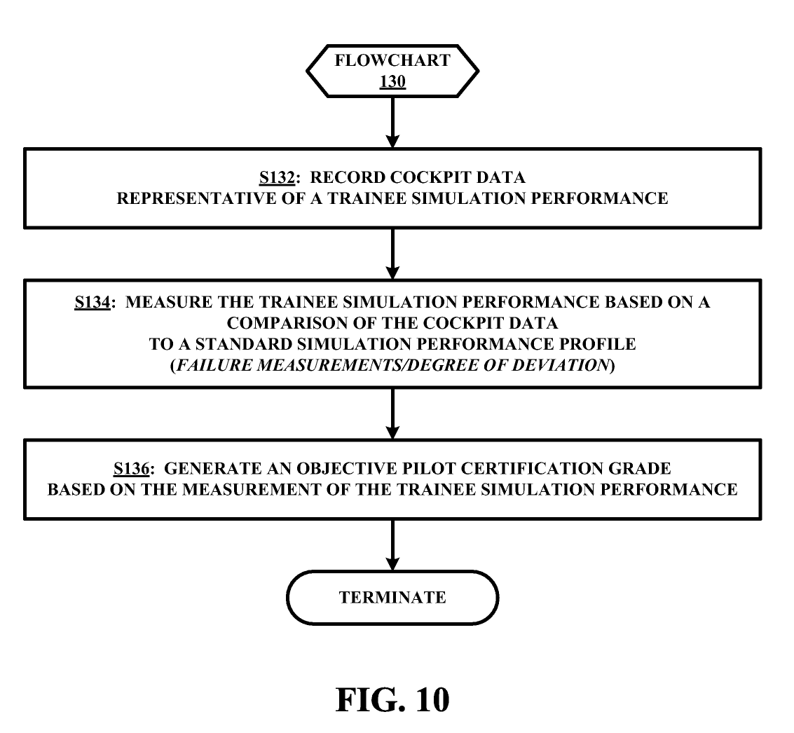

In one embodiment, the certified on-line simulation testing is conducted in accordance with a flowchart 130 illustrated in FIG. 10 that is representative of a simulation performance grading method of the present invention.

A stage S132 of flowchart 130 encompasses trainee client devices 20 and/or system 40 recording cockpit data representative of a trainee simulation performance. As related to flight training, the cockpit data will represent a flight path by the trainee from takeoff to landing in terms of altitude, airspeed, and control surface movements (e.g., elevators, ailerons, rudder, trim, spoiler on the pitch, roll and yaw axis).

A stage S134 of flowchart 130 encompasses trainee client devices and/or system 40 measuring a trainee simulation performance based on a comparison of the cockpit data to a standard simulation performance profile. As related to flight training, the comparison will involve two types of measurement. The first type is directed to failure measurements related to the simulation trainee crashing or damaging the aircraft under a specified set of flying conditions. For example, a crash under clear weather conditions will result in an automatic certification failure while a crash under serve but manageable weather conditions may result in a certification failure in view of specific information provided by the cockpit data.

The second type is directed to a degree of deviation between a trainee simulation performance as represented by the cockpit data and the standard simulation performance profile. The degree of deviation can be measured in terms of a specific portion of a mission, flying conditions and/or any other parameter or parameters indicative of the trainees ability to fly.

A stage S136 of flowchart 130 encompasses system 40 objectively generating a pilot certification grade based on the measurement of the trainee simulation performance. The grade can be a pass or fail, or be based on a numerical system. The benefit of state S136 is to make a certified instructor's evaluation of the simulation trainee less objective and more based on actual performance data. To this end, as shown in FIG. 9, a post-certification stage S126 of flowchart 120 encompasses system 40 providing exam and simulation testing results to simulation trainee(s) and an automatic or trainer directed provision of a certification record to the appropriate certification body (e.g., FAA or DoD). In the case of the trainer directed provision of the certification record, the instructor can have the option of taking the simulation trainee back through stages S122 and S124 based on the exam and testing results to help the simulation trainee improve upon certain aspects.

Referring to FIGS. 9 and 10, those having ordinary skill in the art will appreciate numerous benefits of the present invention, including, but not limited to, a expedient, dynamic, relatively inexpensive, complex yet objective means for certifying trainees. Further, those having ordinary skill in the art will appreciate how to apply the inventive principles of the present invention as described in FIGS. 9 and 10 to any type of transportation machine.

From the description herein of the present invention, those having ordinary skill in the art of PC-based simulation training will appreciate how to apply the inventive principles of the present invention as described in FIGS. 1-10 to interactive environments that are more or less complex than the interactive environment shown in FIG. 1. In addition, referring to FIG. 1, those having ordinary skill in the art will appreciate the training functionality of a PC-based simulator in accordance with the present invention (e.g., simulation training multimedia application 50 shown in FIG. 3) is either within trainee client domain 20, simulation training server system 40, and/or distributed across trainee client domain 20 and simulation training server system 40. In the distributed embodiment, trainee client domain 20 would have limited functionality, such as, for example, an aircraft sitting in a hanger, cold, powered off, without a key, without active systems, unable to see the environment, and unable to perform flight tasks defined as an operator, pilot, or war fighter. Trainee client domain 20 through communication among trainee client devices and/or simulation training server system 40 would provide the training functionality of the PC-based simulator of the present invention. Trainee client domain 20 can interact with simulation training server system 40 across network 10 in the form of encrypted networks, layered with security, across the Internet, intranet, securenet, LAN, WAN, or distributed architecture network. Trainee client domain 20 and simulation training server system 40 communicate using 2-way communications to effect the operations of the PC-based simulator via the simulation trainee(s).

The term “processor” as used herein is broadly defined as one or more processing units of any type for performing all arithmetic and logical operations and for decoding and executing all instructions related to facilitating an execution of the various methods of the present invention. Additionally, the term “memory” as used herein is broadly defined as encompassing all storage space in the form of computer readable mediums of any type.

Furthermore, those having ordinary skill in the art of PC-based simulation training may develop other embodiments of the present invention in view of the inventive principles of the present invention described herein. Thus, the terms and expression which have been employed in the foregoing specification are used herein as terms of description and not of limitations, and there is no intention in the use of such terms and expressions of excluding equivalents of the features shown and described or portions thereof, it being recognized that the scope of the present invention is defined and limited only by the claims which follow.

I claim:

1. A simulation training system, comprising:
a trainee client domain including at least one trainee client device;
a simulation training server system including at least one simulation training server; and
a network system establishing communication between the trainee client domain and the simulation training server system,
wherein the trainee client domain and the simulation training server system are operable to provide an objective simulation certification indicative of a simulated operation of a transportation machine by a simulation trainee.

2. The simulation training system of claim 1, wherein the objective simulation certification is based on a recording of data representative of a trainee simulation performance by the simulation trainee.

3. The simulation training system of claim 2, wherein the trainee simulation performance is measured based on a comparison of the recorded data to a standard simulation performance profile.

4. The simulation training system of claim 3, wherein the comparison of the recorded data to the standard simulation performance profile includes a failure measurement of the recorded data relative to the standard simulation performance profile.

5. The simulation training system of claim 3, wherein the comparison of the recorded data to the standard simulation performance profile includes a degree of deviation of the recorded data from the standard simulation performance profile.

6. The simulation training system of claim 3, wherein a trainee certification grade is objectively generated based on the measurement of the trainee simulation performance.

7. The simulation training system of claim 1, further comprising:
a trainer client domain including at least one trainer client device,
wherein the network system establishes communication between the trainer client domain and at least one of the trainee client domain and the simulation training server system, and
wherein the trainer client domain is operable to provide simulation training courseware specifying an objective simulation testing of the simulated operation of the transportation machine by the simulation trainee.

8. The simulation training system of claim 1, further comprising:
a simulation database system including at least one database server,
wherein the network system establishes communication between the simulation training server system and the simulation database system, and
wherein the simulation database system is operable to store and facilitate a viewing of the objective simulation certification of the simulation trainee.

9. A simulation training system, comprising:
a processor; and
a memory storing instructions operable with the processor for executing an interaction among distinct modules facilitating a simulation of a transportation machine for purposes of conducting an objective simulation certification indicative of a simulated operation of the transportation machine by a simulation trainee, the instructions being executed for:
a transportation machine module providing a model of the transportation machine,
a scenario/mission module providing at least one of a scenario and a mission associated with the simulated operation of the transportation machine by the simulation trainee, and
an environment module providing environmental setting associated with the simulated operation of the transportation machine by the simulation trainee.

10. The simulation training system of claim 9, wherein the modules are implemented in a layered module integration format including
the environment module defining the environmental setting,
the scenario/mission module defining the at least one of the scenario and the mission within the defined environmental setting, and
the transportation machine module defining the model of the transportation machine within the defined environmental setting based on the at least one of the defined scenario and the defined mission.

11. The simulation training system of claim 9, wherein the instructions are further executed for:
implementing the simulation trainee as an operator of the modeled transportation machine within the environmental setting.

12. The simulation training system of claim 9, wherein the instructions are further executed for:
a physical interface module providing at least one communication channel between the simulation training system and the simulation trainee.

13. The simulation training system of claim 9, further comprising:
at least one training client device including the processor and the memory.

14. The simulation training system of claim 9, further comprising:
at least one simulation training server including the processor and the memory.

15. The simulation training system of claim 9, further comprising:
at least one trainee client device (20);
at least one simulation training server (40); and
a network system establishing communication between the at least one trainee client device and the at least one simulation training server (40), wherein the processor and the memory are distributed across the at least one trainee client device and the at least one simulation training server.

16. The simulation training system of claim 9, wherein the objective testing of the simulation trainee includes a recording of data representative of a trainee simulation performance of the simulation trainee.

17. The simulation training system of claim 16, wherein the objective testing of the simulation trainee further includes a measurement of the trainee simulation performance based on a comparison of the recorded data to a standard simulation performance profile.

18. The simulation training system of claim 17, wherein the comparison of the recorded data to the standard simulation performance profile includes a failure measurement of the recorded data relative to the standard simulation profile.

19. The simulation training system of claim 17, wherein the comparison of the recorded data to the standard simulation performance profile includes a degree of deviation of the recorded data from the standard simulation performance profile.

20. The simulation training of claim 17, wherein the objective testing of the simulation trainee further includes an objective generation of a trainee certification grade based on the measurement of the trainee simulation performance.
